(19) United States
(12) Patent Application Publication
(10) Pub. No.: US 2005/0209934 A1
(43) Pub. Date: Sep. 22, 2005

(54) System, apparatus and process to provide, replenish, monitor, and invoice consignment inventory with retail customers

(76) Inventors: Sean Irby, Fountain Valley, CA (US); Robert Jones, Long Beach, CA (US); Ted Wong, Torrance, CA (US); Sam Park, Lake Forest, CA (US)

Correspondence Address: Roger R. Wise;PILLSBURY WINTHROP LLP, Suite 2800, 725 South Figueroa Street, Los Angeles, CA, 90017, US

(21) Appl. No.: 10/802,511

(22) Filed: Mar. 17, 2004

(51) Int. Cl. G06F 17/60

(52) U.S. Cl. 705/28

(57) ABSTRACT

A consignor and a retailer develop a consignment agreement for a consigned product. An inventory order is generated for stocking levels of the consigned product in a retailer's distribution system. An inventory quantity of the consigned product based on the inventory order is shipped out to the retailer's distribution system. A virtual inventory is created in a consignor's computer system to match the inventory quantity shipped to the retailer's distribution system and also that identifies the inventory location. A consignor's computer system receives sales data for the consigned product. The retailer's distribution system is replenished based on the sales data. The virtual inventory in the consignor's computer system is decremented based on the sales data received.

### BACKGROUND OF THE INVENTION

Large, high-cost electronic devices, such as projectors, high-definition televisions, plasma televisions, are being distributed by multiple retailers, including office-supply chains. The retail office supply chains, e.g., Staples, OfficeMax, Office Depot, etc., are looking to distribute and sell products having a higher profit margin than smaller electronic devices like personal digital assistants, personal computers, all-in-one printers, laser and inkjet printers, etc, or office supplies. Unlike specialty electronic stores which focus mainly or exclusively on, for example, high-definition televisions, the retail supply chains would like to become a “one-stop shop” to small, medium, and large size business by providing all levels of electronic products. By providing all levels of electronic products, the retail stores may then be able to increase their profitability and customer satisfaction levels. Across the whole spectrum of products, retailers are becoming increasingly reluctant to carry large inventories even when manufacturers offer liberal return policies. The physical expense of storing inventory and then returning the unsold portions has some effect on bottom-line profits. By consigning for an inventory of considerable lot size and having guaranteed availability without product storage issues, a consignment method is appealing to retailers of low-priced products as well. If retailers do not have responsibility or issues with inventory, consumers may end up with more choices at lower prices.

A problem in selling high-end or costly electronic devices is that the inventory costs associated with stocking the high-end electronic devices are normally prohibitive. In order to have the costly electronic items available to consumers who want to purchase the devices, it is desirable for each retail location to stock at least two models of each of the high-end electronic devices. If the high-end electronic device is stocked at the retail sales location, the consumer or customer may be able to test, view, or watch a demo of the high-end electronic device immediately. This availability makes a favorable impression on the consumer and leads to increased sales.

The cost for a national retail chain, such as a Staples or Office Max, to stock high-end electronic items at each retail sales location is prohibitive and thus this product stocking strategy is difficult to implement. Because consumers want products on-site for demonstration purposes or perhaps for immediate delivery, the sales of the high-end electronic items may be reduced because the products are not available in the retail sales locations.

In addition, if a retail chain does stock the high-end electronics item and the high-end electronics item does not generate the forecasted sales, the retail chain may build up a large inventory of the high-end electronic items. Under some arrangements with certain equipment vendors or suppliers, there are no return contract provisions, and therefore the inventory of the high-end electronic device may need to be discounted or scrapped. In addition, if the vendor or supplier goes out of business and the high-end electronic device is not selling well, the inventory of electronic devices may need to be significantly discounted or scrapped.

Under other vendor—retailer arrangements, returns are possible, but additional administrative costs are incurred because the inventory is physically transferred back from the retailer to the supplier. In addition, the inventory billing system for both the retailer and the supplier will need to be adjusted for the inventory that was originally transferred to the retailer and now is being transferred back to the supplier.

Accordingly, a need exists for a retailer/distributor system that minimizes the retailer's inventory costs, maximizes the product availability of the supplier's products, maximizes the sales of the supplier's products, and enhances the speed of the payment made by the retailer to the supplier.

### BRIEF DESCRIPTION OF THE DRAWINGS

FIG. 1 illustrates a consignment system network according to an embodiment of the present invention;

FIG. 2 illustrates a consignor or supplier computing system;

FIG. 3 illustrates a flowchart detailing a method to provide, replenish, monitor, and invoice consignment retail customers; and

FIG. 4 illustrates a detailed method of the consignment inventory/billing process in a supplier and retailer environment according to an embodiment of the present invention.

### DETAILED DESCRIPTION OF THE INVENTION

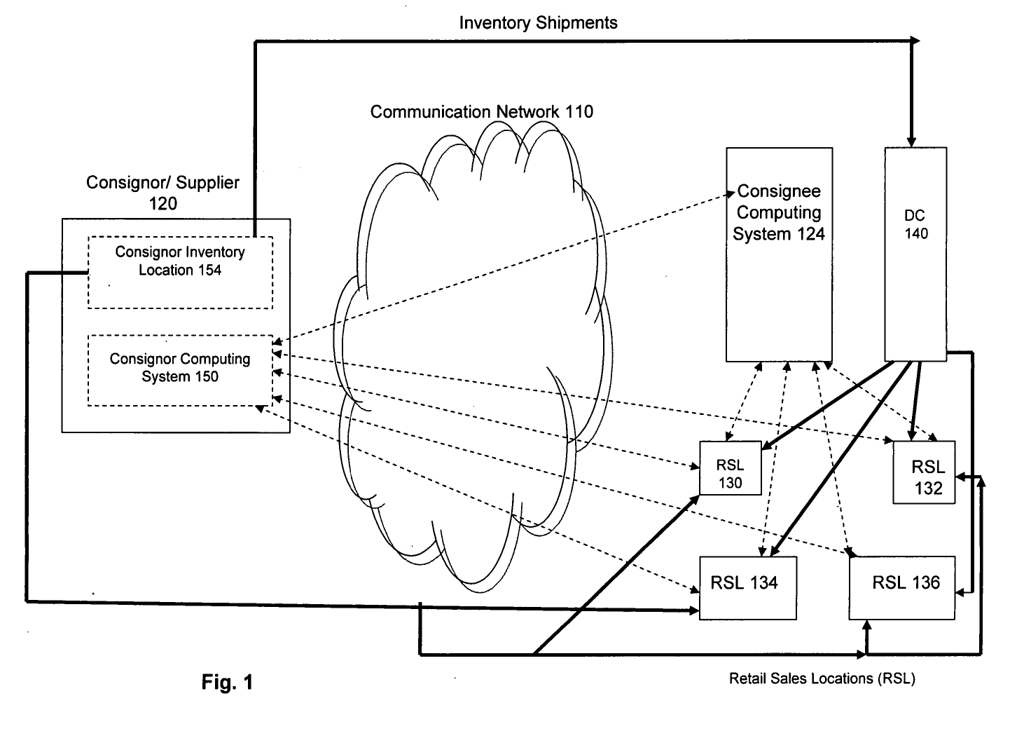

FIG. 1 illustrates a consignment system network according to an embodiment of the present invention. The consignment system includes a consignor/supplier 120, a communication network 110, a consignee computing system 124, a consignee distribution center 140, and consignee retail sales locations 130, 132, 134, and 136. The consignor/supplier 120 may include a consignor computing system 150 and a consignor inventory location 154.

The consignment system of the present invention enables the consignor to retain ownership and/or financial responsibility for the consigned product until the consigned product is sold at a consignee, e.g., retailer sales location. The consignment system may be utilized with multiple consignees or retail partners. In addition, the consignment system may be utilized to support a plurality of consigned products. For simplicity, most of the discussion is focused on a single consignee partner that is distributing a single consigned product, but multiple products and multiple vendors or customers are supported by the consignment system of the present invention.

The consignment system is designed to make the vendor (consignor) more responsive to channel's, or the consignees', fulfillment. In other words, because the vendor or consignor owns the inventory and does not get paid until the inventory is sold, the vendor is more responsive in managing the various consignees' inventory and in listening to the consignees' concerns. The vendor is motivated in the present invention's consignment system to develop good analyzation tools and monitoring tools to increase inventory turns, to increase product availability at consignee or retailer locations, to monitor the effectiveness of consignor-provided or -supported adverting and promotional programs, and to increase payment turnaround time from consignee to consignor.

The consignor computing system 150 includes software that handles inventory management and financial recordkeeping functions for the consignor/supplier. The consignor computing system 150 may be installed on any type of computing device such as, but not limited to, a server, a plurality of servers, a personal computer, a laptop computer, a minicomputer, a mainframe computer, and a supercomputer, and a combination of at least two of a server, a laptop computer, and a personal computer.

The consignor inventory location 154 may be a warehouse, a plurality of warehouses, or a plurality of managed distribution centers.

The consignee computing system 124 includes software that handles inventory management and financial recordkeeping functions for the consignee or retailer. The consignee computing system 124 may be installed on any type of computing device such as, but not limited to, a server, a plurality of servers, a personal computer, a laptop computer, a minicomputer, a mainframe computer, and a supercomputer, and a combination of at least two of a server, a laptop computer, a personal computer, a minicomputer, a laptop computer, and a personal computer.

The consignee distribution center 140 stocks inventory of the consigned products for the consignee distribution system. The consignee distribution center 140 may be a warehouse or a plurality of warehouses, depending on the size of the consignee distribution system. The consignee distribution center 140 receives consigned products from the consignor inventory location 154 and distributes the inventory to the consignee retail sales locations 130, 132, 134, and 136, to make the inventory of consigned products available for purchase by consumers.

The consignor or supplier may negotiate a consignment agreement with the consignee or retailer. Included in the consignment agreement may be an agreement on initial consignment stocking levels for products being sold utilizing the consignment model, payment requirements for both the consignor and the consignee, insurance liability, local tax liability, return policies, physical audits, and other business arrangements. The terms of the consignment agreement may be entered into the consignor computer system 150.

The consignor computer system 150 may transmit a request to the consignor inventory location 154 to ship a first inventory quantity of a consigned product from the consignor inventor location 154 to the consignee distribution center 140 based on initial consignment requirements. The request may be transmitted using wired transmission protocols or wireless transmission protocols. In an embodiment of the invention, the request may be transmitted over a global communications network 110, e.g., the Internet. In an embodiment of the invention, the request may include instructions to ship a first inventory quantity of multiple consigned products to the consignee distribution system. For simplicity, only one consigned product is discussed.

In an embodiment of the invention, the first inventory quantity of consigned products may be shipped from the consignor inventory location to the consignee or retailer distribution center 140. In an embodiment of invention, an inventory quantity may be shipped from the consignor inventory location 154 directly to one or more of the retailer locations. FIG. 1 illustrates retail sales locations 134 and 136 receiving an inventory quantity from the supplier or consignor inventory. A consigned product may be shipped directly to the retailer sales locations in situations where the availability is time-critical, the consignee distribution center 140 has depleted inventory, or it is more cost-efficient for the consigned product to be shipped from the consignor inventor location 154 directly to the retail sales location 130, 132, 134, or 136.

The consignor or supplier computer system 150 transmits an inventory update to the consignee computer system 124. The consignor or supplier computer system 150 creates a virtual inventory location within the consignor or supplier computer system 150. The virtual inventory location within the consignor computer system 150 is established to replicate or copy the actual inventory in the consignee or retailer distribution system, i.e., the retailer distribution center 140 and the retail sales locations 130, 132, 134, and 136. The virtual inventory location is created in order for the consignor to maintain ownership of and thus, financial responsibility for, the first inventory quantity of the consigned product that has been shipped to the consignee distribution system.

The consignee computing system 124 receives the inventory update from the consignor computer system 150 and maintains records of the location of each of the consigned products in the consignee distribution system. The inventory update may be transmitted through a communications network, e.g., a communication network 110. In an embodiment of the invention, the consignee or retailer distribution center 140 maintains a certain stocking level of the consigned product and transfers the remainder of the consigned products to the retail sales locations 130, 132, 134, and 136. The consignee computing system 124 maintains a record of a location of each of the consigned product, e.g., 4 consigned products in the consignee distribution center, 1 consigned product in retail sales location 130, 132, and 134, and 2 consigned products in retail sales location 136. In an embodiment of the invention, the consignee computing system 124 does not maintain any financial information regarding ownership of the consigned products initially because the consignor or supplier still owns the consigned product.

After the first inventory quantity has been distributed through the consignee or retailer distribution system, consumers or business professionals may enter the retail sales locations 130, 1-32, 134, and 136 and make a decision to purchase the consigned products. In other words, sales of the consigned products may occur. The consignee computing system 124 may monitor the sales at each of the retail systems on a periodic basis or for a specified timeframe. In an embodiment of the invention, the consignee computing system 124 may monitor the sales in real-time or an hourly basis. In other embodiments of the invention, the computing system 124 may monitor the sales on a daily basis or on a weekly basis. In an embodiment of the invention, the consignor or supplier computing system 150 may monitor the sales from the retail sales locations 130, 132, 134, or 136 either in place of the consignee computer system 124 or in combination with the consignee or retailer computer system. The consignor or supplier computing system 154 may monitor the sales utilizing the communications network 110. In an embodiment of the invention, the retail sales locations 130, 132, 134, or 136 may transmit the sales information to the consignee computing system 124 or the consignor computing system 150 utilizing wireless or wired communication protocols.

In the embodiment of the invention where the sales information is reported to the consignee computing system 124 as part of the monitoring process, the sales information is then transmitted from the consignee computing system 124 to the consignor computing system 150. Once the consignor computing system 150 receives the sales information, whether from the consignee system 124 or directly from the retail sales locations 130, 132, 134, and 136, the consignor computing system 150 compiles the sales information for the entire retail or consignee distribution system for a specified timeframe. After the sales data has been compiled, the consignor computing system 150 decrements the sales reported from the consignor virtual inventory. For example, if one consigned product is sold in each of retail sales locations 132 and 136, then the consignor virtual inventory is adjusted to identify that these two locations have one less consigned product.

In the financial reporting module of the consignor or supplier computing system, new accounts receivables record(s) are generated corresponding to the sales out data or sales reported. This is part of the process of transferring ownership and financial responsibility for the consigned product from the consignor to the consignee. An invoice is also generated by the consignor computing system which corresponds to the sales out data or sales reported. The invoice may be transmitted electronically to the consignee computing system 124 or may be sent to the consignee computing system 124. If the invoice is transmitted electronically, the invoice may be transferred utilizing an Electronic Data Interchange (EDI) protocol or other well-known protocols. In response to the consignee computing system 124 receiving the invoice, the consignee accepts financial responsibility for the sold consigned products and a financial portion of the consignee computing system 124 processes the submitted invoice in order to pay the amount requested on the invoice. In one embodiment of the invention, the financial portion of the consignee computing system 124 may create a check that is sent to the consignor or supplier. In an embodiment of the invention, the financial portion of the consignee computing system may send an electronic payment or authorization to make an electronic payment to the consignor, e.g., may send an authorization to transfer money from the consignee's bank account to the consignor's bank account.

Once payment is received for the consigned product invoice, the consignor or supplier computing system 150 zeroes out or reduces the amount of the accounts receivable record corresponding to the consigned product invoice. The sales out information or sales data also provides information necessary to replenish the consignee inventory system with the consigned products.

The consignor or supplier computing system 150 utilizes the sales out data or sales information as a tool in deciding a replenishment inventory quantity that is to be shipped to the consignee or retailer distribution system. The consignor or supplier computer system 150 may also utilize advertising information or forecasting information for specific timeframes to assist in determining the size of the replenishment quantity and the locations at which the replenishment quantity of consigned products may be stocked. For example, each of the consignee retail sales locations 130, 132, 134, and 136 may have sold the two consigned products stocked at their location. Thus, in order to replenish only the consignee retail store locations for their sold consigned products, the consignor computing system 150 would submit a request to ship at least eight consigned products to the consignee distribution center 140, and two of the eight consigned products would be designated for shipment to each of the retail sales locations 130, 132, 134, and 136.

In this example, the consignor may also have knowledge that the consignee plans to run advertising for the next measured period, e.g., one week, for two of the consignee retail sales locations. In such a case, the consignor is aware that sales will normally double in retail sales locations where advertisements are run. However, the consignee has not, as of the time the consigned products will be shipped, decided which retail sales locations 130, 132, 134, or 136 will have advertising in the corresponding retail sales locations. Thus, the consignor believes that four more consigned products or units should be shipped to the consignee distribution system. Because the consignee does not know where the advertising will be run, the additional consigned products or units will be shipped initially to the consignee distribution center 140 and later transferred out to the retail sales locations 130, 132, 134, or 136 corresponding to the areas where the advertising is run.

After the determination of the replenishment inventory quantity has been made and the replenishment inventory quantity has been shipped to the consignee distribution system, the virtual inventory in the consignor or supplier computer system is updated to reflect the number of consigned products in the consigned distribution system.

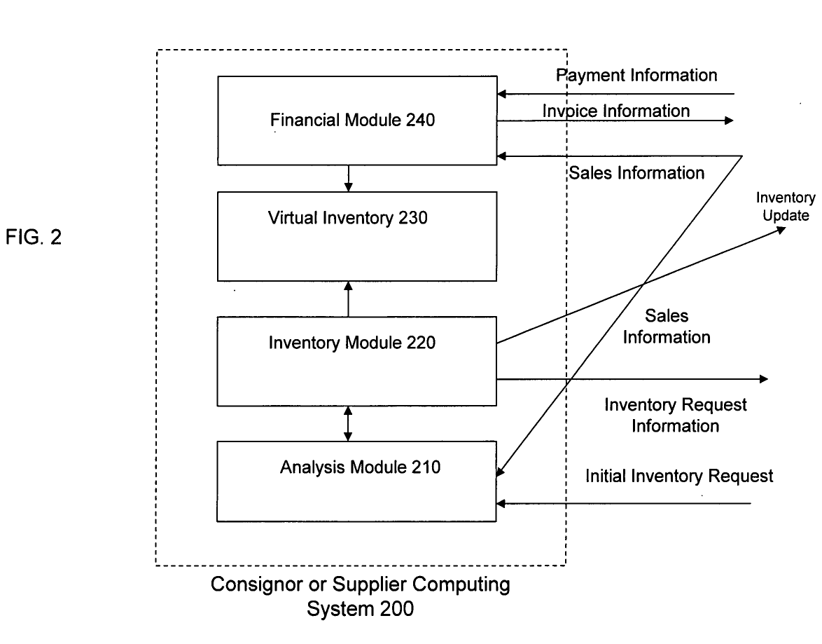

FIG. 2 illustrates a consignor or supplier computing system. The consignor or supplier computing system 200 includes an analysis module 210, an inventory module 220, a virtual inventory module 230, and a financial module 240.

In an embodiment of the invention, a consignment agreement may be negotiated and completed between the consignor/supplier and the consignee/retailer. As part of the consignment agreement or after the consignment agreement has been executed, an initial inventory stocking request may be submitted by the consignee. The initial inventory stocking request may identify the proposed stocking levels for the consigned product(s) at each location within the consignee distribution system, e.g., the consignee distribution center 140 (see FIG. 1) and the various consignee retail sales locations 130, 132, 134, and 136.

The initial inventory stocking request may be input manually or transmitted electronically to the analysis module 210 of the consignor or supplier computing system 200. In an embodiment of the invention, the analysis module 210 may automatically determine if the inventory stocking levels are acceptable to the consignor. In this embodiment, the analysis module 210 may accept the inventory stocking levels as submitted in the inventory stocking request or the analysis module may adjust the proposed inventory stocking levels at all or some of the locations in the consignee distribution system. In this embodiment of the invention, personnel employed by the consignor may enter inventory stocking rules into the analysis module 210 in advance of the inventory stocking request being submitted and the inventory stocking rules may be applied to the inventory stocking request. In an embodiment of the invention, a consignor employee may manually review the inventory stocking request, and may accept the inventory stocking request as is or adjust the proposed stocking levels. After the analyzation is complete, the analysis module 210 submits an initial stocking level report to the inventory module 220.

The inventory module 220 receives the initial stocking level report and transmits an inventory shipping request to the consignor inventory location 154 (see FIG. 1). The inventory shipping request identifies the quantities of consigned products that are to be shipped from the consignor inventory location 154 to the consignee distribution system. In an embodiment of the present invention, the inventory shipping request may also identify the quantity of consigned products that are to remain at a consignee distribution center 140 and also the quantity of consigned products that are to be sent to each of the retail sales locations 130, 132, 134, and 136.

The inventory module 220 transmits an inventory update to the consignee or retailer computing system 124 (see FIG. 1). The inventory update identifies that the quantity of consigned products that was shipped from the consignor inventory location 154 to the consignee distribution system. The inventory update information also identifies the stocking locations for the quantity of consigned products, i.e., it identifies how many consigned units may be assigned to the consignee distribution center and how many consigned units may be assigned to the each of the consignee retail sales locations.

The inventory module 220 also utilizes the initial stocking level report to establish a virtual inventory structure/record in the virtual inventory module 230. The virtual inventory structure/record is established to keep track of inventory levels at each location in a consignee or retailer's distribution system. In an embodiment of the invention, a virtual inventory record may be established for each consignee, e.g., retailer like Staples or Office Depot, that is receiving consigned products from the consignor. For ease of illustration in the present discussion, interaction with only one consignee or retailer is considered. In an embodiment of the invention, the virtual inventory record or structure may include a list of entries, wherein each entry corresponds to a consignee inventory location, such as a distribution center 140 or a retail sales location 130, 132, 134, or 136. For example, the virtual inventory record or structure may be established as follows:

| Consignee Inventory Location | Number of Consigned Products |
|---|---|
| Consignee Distribution Center | 6 consigned products |
| (Barstow, CA) | |
| Retail sales location 1 (Las Vegas, | 3 consigned products |
| Nevada) | |
| Retail sales location 2 (Santa | 2 consigned products |
| Barbara, California) | |
| Retail sales location 3 (Modesto, | 2 consigned products |
| California) | |
| Retail sales location 4 (Downtown | 3 consigned products |
| Los Angeles) | |

The consignor computing system 200 establishes the virtual inventory record or structure in the virtual inventory module 230 to allow the consignor to maintain ownership and financial responsibility of the shipped consigned products while, at the same time or at some time later, physically shipping the consigned products to the consignee distribution system.

Once the consigned products are stocked in the consignee or retailer's distribution system, consumers may begin to purchase the consigned products at the consignee's retail locations 130, 132, 134, and 136. In an embodiment of the invention, sales data at each of the consignee's retail locations 130, 132, 134, and 136 may be captured in real-time and transmitted in real-time, using wired or wireless methods, to the consignee computing system 150. In this embodiment of the invention, sales information or sales out data is transferred from the consignee computing system 124 to the consignor or supplier computing system 200. In an embodiment of the invention, sales data at each of the consignee's retail locations 130, 132, 134, and 136 may be captured in real-time and transmitted in real-time, using wired or wireless methods, to the consignee computing system 124, and also the consignor computing system 200.

The financial module 240 of the consignor or supplier computing system 200 may receive the sales information or sales out data. In an embodiment of the invention, the financial module 240 may transmit invoice information to the consignee computing system 124 based on the sales information received. The invoice information may be transferred via any conventional means, such as electronically via standard payment computer interfaces, such as EDI, via facsimile, via e-mail, or via postal mail. The invoice information may also be made available to the consignee if the consignee utilizes a communications network 110, e.g., the Internet, to logon to a site established by the consignor or supplier.

In an embodiment of the invention, once an invoice has been created for the consigned products sold by the consignee or retailer, the financial module 240 may communicate with the virtual inventory module 230 to decrement the sold products from the virtual inventory record. For example, utilizing the table from above, if one product is sold at the Modesto retail sales location of the consignee distribution system, them the corresponding entry in the virtual inventory record is decremented by one.

An account receivable record is created for each consigned product sold. The accounts receivable also corresponds to (the) number of consigned products identified as transferred out of the virtual inventory record. Illustratively, in an embodiment of the invention, if ten consigned products are sold at various consignee retail sales locations, an accounts receivable record is created which identifies the total amount due, the number of consigned units sold, and the location from which the consigned units were sold. In most situations, the total amount due in the accounts receivable record is equal to the dollar amount of the invoice. Some situations may arise due to discounting or promotional campaigns where the amount due may be smaller or larger than the amount provided in the invoice.

In response to the invoice information, a financial module of the consignee computing system 124 may transmit payment information or payment authorization to the financial module 240. The payment information or authorization may be transferred via EDI. The payment information or authorization may be a transmission from a consignee financial institution authorizing the transferring of funds to the consignor financial institution, where the consignor financial institution transmits payment information, i.e., that the payment has been received, to the financial module 240 of the consignor or supplier computing system.

The consigned product inventory of the consignee distribution system is replenished after consigned products have been sold. On a periodic basis, the analysis module 210 may receive sales information or aggregated sales information for the time period being monitored. The periodic basis may be, for example, every few hours, every Y₂ day, every day, or every week. In an embodiment of the invention, the analysis module 210 may utilize the aggregated sales information for the time period being measured and create an inventory replenishment recommendation corresponding directly to the aggregated sales information. In this embodiment, the analysis module 210 is just recommending a one-for-one replacement for any consigned products which were sold. Thus, for example, if two consigned products were sold at the Las Vegas retail sales center and three consigned products were sold at the Los Angeles retail sales center, the analysis module would create a replenishment recommendation to ship five units from the consignor inventory location 154 to the consignee distribution center 140, or alternatively directly to the Las Vegas retail sales location (2 consigned products) and to the Los Angeles retail sales location (3 consigned products).

In an embodiment of the invention, the analysis module 210 may utilize the sales information or aggregated sales information as one factor in creating an inventory replenishment recommendation. Other factors may include the inventory at the consignee's distribution center, the inventory at the consignee's inventory location, advertising expected during the period of time being monitored, sales promotions expected during the period of time being monitored, and historical trends of sales of these similar consigned products during the same or similar time periods.

In an embodiment of the present invention, the analysis of the factors may be performed by an operator of the consignor or supplier computing system. In an embodiment of the invention, the analysis of factors may be performed by the analysis module 210 of the consignor or supplier computing system 200. The analysis module 210 may utilize previously input rules or artificial intelligence in utilizing the factors described above to help create an inventory replenishment recommendation. After the analysis has been completed, the replenishment recommendation is transmitted to the inventory module 220 and a final inventory replenishment order is created.

The final inventory replenishment order is transmitted from the inventory module 220 to the consignor inventory location 154 in order to have the consignor inventory location 154 prepare shipment of the consigned products, designated for replenishment of the sold consigned products, to the consignee distribution system. The consignor inventory location 154 can also be instructed to prepare shipment of the consigned products directly to the consignee retail sales locations 130, 132, 134, and 136.

The final inventory replenishment order is also transferred from the inventory module 220 to the virtual inventory module 230 to allow the virtual inventory module 230 to update the virtual inventory record with the replenished consigned product. For example, if the final inventory replenishment order includes an instruction to ship four consigned products to the Los Angeles retail sales location, then the virtual inventory record entry corresponding to the Los Angeles retail sales location in the virtual inventory module 230 is updated to reflect the addition of four consigned products.

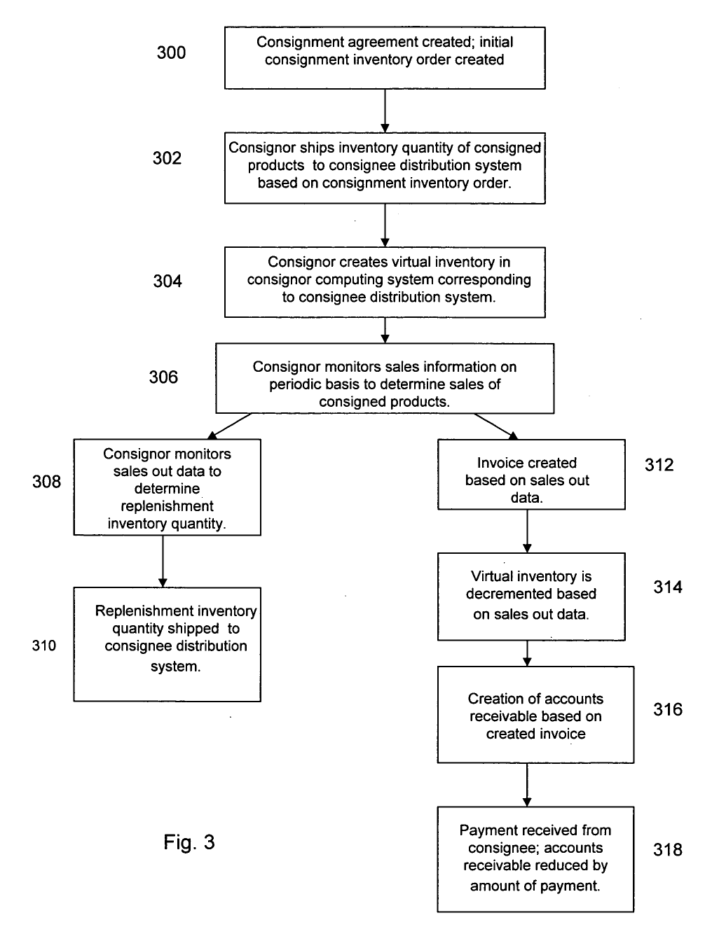

FIG. 3 illustrates a flowchart detailing a method to provide, replenish, monitor, and invoice consignment retail customers. A consignor and a consignee, e.g., a supplier and a retailer, create 300 a consignment agreement which includes a forecast for sales of a consigned product. The consignment agreement may also include an initial consignment inventory request. In an embodiment of the invention, the consignment agreement may include a first consignment inventory order if the consignor agrees to an initial consignment inventory request generated by the consignee. If the initial consignment inventory request has not been approved by the consignor or supplier, the consignor or supplier analyzes the initial consignment inventory request and order and makes inventory adjustments. The consignor or supplier utilizes a series of factors, such as the inventory at the consignor's inventory location, advertising expected at the retail sales locations, sales promotions expected at the retail sales locations, and historical trends of sales of similar products to the consigned products in the consignee distribution channel, to assist in analyzing the request. After the analyzation has been performed, either automatically by software residing in a computing device or manually by consignor personnel, a first consignment inventory order is created.

Based on the first consignment inventory order, a consignor ships 302 a quantity of inventory of consigned products corresponding to an inventory quantity identified on the inventory order to the consignee distribution system. In an embodiment of the invention, the consigned products are shipped to a consignee distribution center, which in turn ships the consigned products to a plurality of retail sales locations. In an embodiment of the invention, the consigned products are shipped only to a plurality of retail sales locations or to a combination of at least one distribution center and a plurality of retail sales locations.

The consignor also creates 304 a virtual inventory in a consignor computing system which copies or corresponds to inventory stocking levels at the consignee distribution center and the consignee retail sales locations. A record in the virtual inventory may correspond to each consignee with which the consignor has negotiated an agreement. The record may include a plurality of entries with each entry corresponding to a consignee inventory location, i.e., retail sales location and/or distribution center.

The consignor monitors 306 sales information at the consignee retail sales location on a periodic basis or for a specified timeframe. In an embodiment of the invention, the periodic basis or timeframe may include monitoring the sales information in real-time (approximately the same time the sales are made at the retail sales locations or within an hour after the sales are made). In this embodiment of the invention, the retail sales locations may utilize a communications network to directly feedback sales information to the consignor computing system. In an embodiment of the invention, the retail sales location may utilize radio frequency transmissions, such as radio frequency identification devices (RFIDS) to directly feedback sales information to the consignor computing system. In this embodiment of the invention, the consignor computing system aggregates the reported sales information (from the retail sales locations) for a designated timeframe, e.g., every few hours or every day, etc.

In an embodiment of the invention, the reported sales information, sometimes referred to as sales-out data, may be transmitted to a consignee computer system, which aggregates the sales out data for most of or the entire consignee distribution system. The aggregated sales-out data is then transmitted to the consignor computer system.

Personnel of the consignor evaluate, or the consignor computer system evaluates, the sales-out data and the inventory position of consignee distribution system to determine 308 a replenishment inventory quantity to be shipped to the consignee distribution system. The sales-out data is evaluated along with other factors such as the inventory at the consignee's distribution center, the inventory at the consignee's inventory location, advertising expected during the period of time being monitored, sales promotions expected during the period of time being monitored, and historical trends of sales of these consigned products during the same or similar time periods.

The replenishment inventory quantity of consigned products is shipped 310 to a consignee distribution system. Also included are recommendations for the stocking levels of a distribution center and the plurality of retail sales locations.

The sales-out data or sales information is reported 312 to a financial module or section of the consignor computing system. The financial module utilizes the sales-out data or sales information to create an invoice identifying the amount due from the consignor. The amount due corresponds to the number of consigned products sold during the monitored time period multiplied by the price of each consigned products minus any volume or promotional discounts. The invoice is transmitted to the consignee and the consignee processes the invoice for payment. The payment time from invoice to receipt of payment by the consignor should be minimal because the consignee has already received payment from the consumer or business owner.

The virtual inventory is decremented or adjusted 314 before, during, or after the invoice has been generated. The virtual inventory is decremented based on the reported sales information or sales-out data.

An accounts receivable 316 is also created within the consignor's computing system that corresponds to the amount due on the generated invoice and corresponds to the amount the virtual inventory has been decremented. The financial responsibility for the consigned products then becomes the responsibility of the consignee.

The consignor receives 318 payment from the consignee for the consigned products sold at the consignee retail locations. After payment has been received, the accounts receivable is zeroed out or reduced by the amount of payment received by the consignor.

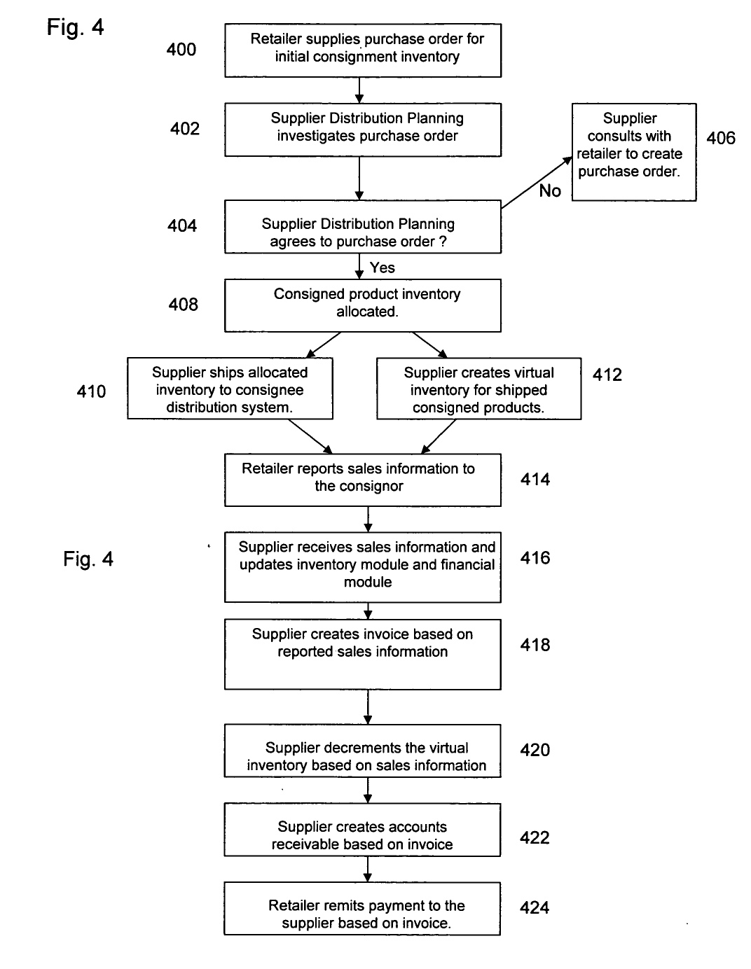

FIG. 4 illustrates a detailed method of the consignment inventory/billing process in a supplier and retailer environment according to an embodiment of the present invention. The retailer 400 supplies a purchase order to the supplier as a suggestion for the initial consignment inventory for the retailer distribution system. The purchase order may be supplied in an Electronic Data Interchange (EDI) format.

In an embodiment of the invention, the consignor distribution planning department receives 402 the purchase order and investigates trends for the consigned product, backlog of the consigned products, promotions for the consigned products, and consignee inventory size/location. After the investigation is complete, the consignor may agree 404 to the purchase order requirements. If the purchase order requirements are not agreed upon, the supplier distribution planning department consults 406 with the retailer to determine an agreed upon recommended purchase order.

After agreement is reached, the consignor enters the purchase order into the consignor computing system and allocates 408 consigned product inventory. The supplier ships 410 the allocated inventory of the consigned products to the retailer's distribution system. If the supplier cannot ship the designated amount of consigned products, per the purchase order, an exception report is created to identify that more consigned product inventory needs to be shipped as soon as the consigned product inventory is available.

The supplier creates 412 a virtual inventory in the supplier computing system for the shipped consigned products which identifies the stocking level of the consigned products at each inventory location in the retailer distribution system.

The retailer reports 414 sales information to the supplier, for example, on an agreed-upon periodic basis. In an embodiment of the invention, the sales information is reported in real-time to the supplier. In an embodiment of the invention, the sales information is made available to the supplier on a real-time basis by the retailer. In this embodiment, the retailer may receive sales information in real-time from a plurality of retail sales locations and may store this sales information in a server and make the server accessible to the supplier via a communications network, such as the Internet.

The supplier receives 416 the sales information and updates both an inventory module of the supplier computer system and a financial module of the supplier computing system. The inventory module acts in a similar fashion as described above in regard to FIG. 3, which describes a method of replenishment of the consigned products for the retailer distribution system.

The financial module of the supplier computing system creates 418 an invoice based on the reported sales data. In an embodiment of the invention, the invoice is transmitted from the supplier to the retailer. In an embodiment of the invention, the invoice is made available to the retailer by the supplier via a server accessible by the communication network, e.g., the Internet.

The supplier computing system decrements 420 the virtual inventory based on the reported sales data. In other words, the virtual inventory is updated to accurately reflect the current state of the consigned product inventory in each of the retailer inventory locations.

The supplier computing system creates 422 an accounts receivable in its financial module based on the reported sales data.

The retailer remits 424 payment to the supplier based on the received invoice or invoice information. As the supplier receives payment, the payment is verified to ensure funds are available. If the payment is verified, the supplier then reduces the accounts receivable by the payment amount received from the retailer.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A method of consigning at least one product between a consignor and a retailer, comprising:
generating an inventory order for stocking levels of the least one consigned product in a retailer's distribution system;
shipping an inventory quantity of the at least one consigned product based on the inventory order to the retailer's distribution system;
creating a virtual inventory in a consignor's computer system which matches the inventory quantity shipped to the retailer's distribution system and identifies an inventory location in the retailer's distribution system;
receiving sales data of the at least one consigned products from the retailer's distribution system;
replenishing the retailer's distribution system by shipping a replenishment inventory quantity of the at least one consigned products to the retailer's distribution system;
decrementing the virtual inventory in the consignor's computer system based on the sales data received from the retailer's distribution system,
generating an invoice based on the sales data and transmitting the invoice to a retailer; and
creating an accounts receivable value owed by the retailer based on the sales data.

2. The method of claim 1, wherein receiving the sales data of the at least one consigned products from the retailer's distribution system occurs on a periodic basis.

3. The method of claim 1, wherein the sales data is received in aggregated by a retailer's computer system and then transmitted to the consignor's computer system.

4. The method of claim 1, wherein the sales data is received in real-time directly from a plurality of consignee retail sales locations.

5. The method of claim 4, wherein a consignor computer system aggregates the received real-time sales for a specified time period.

6. The method of claim 1, further including receiving a payment from the retailer and reducing the accounts receivable by the amount of a payment made the retailer.

7. The method of claim 1, further including analyzing a consignment inventory request provided by the retailer utilizing at least one of a group of factors including inventory at a consignee's distribution center, inventory at the consignor's inventory location, advertising expected in a future timeframe, sales promotions expected during the future timeframe, and historical trends of sales of the at least one consigned product during same or similar time periods in the past.

8. A consignor or supplier computing system, comprising:
an analysis module to receive a consignment inventory request, to analyze the consignment inventory request, and to create a verified consignment request;
an inventory module to receive the verified consignment request from the analysis module, to create an initial consignment order, and to transmit the initial consignment order to a consignor inventory location in order for the consignor inventory location to ship consigned products listed on the initial consignment order to a consignee distribution system; and
a virtual inventory module coupled to the inventory module to create a record to identify an inventory quantity of consigned products and an inventory location of the consigned products shipped to the consignee distribution system.

9. The consignor or supplier computing system of claim 8, further including a financial module to receive sales information from the consignment distribution system, to generate an invoice based on the received sales information, to transmit the invoice to a consignee computer system based on the received sales information, to generate a virtual inventory decrement request based on the sales data, and to transmit the virtual inventory decrement request to the virtual inventory module.

10. The consignor or supplier computer system of claim 8 wherein the analysis module receives the sales information, evaluates the sales information along with at least one factor of a group of factors including inventory at a consignee's distribution center, inventory at the consignor's inventory location, advertising expected in a future timeframe, sales promotions expected during the future timeframe, and historical trends of sales of the at least tone consigned product during same or similar time periods in the past.

11. The consignor or supplier computer system of claim 10, wherein the evaluation of the sales information along with the at least one factor of the group of factors is performed automatically by the analysis module of the consignor system.

12. The consignor or supplier computer system of claim 10, wherein the evaluation of the sales information along with the at least one factor of the group of factors is performed by an operator of the consignor or supplier computer system.

13. A consignment system for consigning products from a supplier to a retailer, the system comprising;
a supplier computing system;
a supplier inventory location to house consigned products; and
a retailer computer system to generate an initial consignment request identifying a quantity of consignment products to be shipped from the supplier inventory location and identifying a proposed retailer inventory location at which the consignment products are to be stocked, and to transmit the initial consignment request;
wherein the supplier computer system receives the initial consignment request from a communications network after the retailer computer system has transmitted the initial consignment request to the communications network, analyzes the consignment order to generate an initial consignment order identifying a shipped quantity of the consigned products to be shipped to a retailer distribution system, transmits the initial consignment order to the supplier inventory location; and creates a virtual inventory of consigned products in the supplier computing system that identifies a stocked quantity of consigned products located at each location in the retailer distribution system, and
wherein the supplier inventory location ships the consigned products to the retailer distribution system.

14. The consignment system of claim 13, wherein the retailer distribution system receives the shipped quantity of the consigned products, maintains some of the shipped quantity of consigned products in a retailer distribution center based on the initial consignment order's instructions on how many consigned products are to be maintained at the retailer distribution center, and ships out a remainder of the shipped quantity of consigned products to a plurality of retailer sales locations.

15. The consignment system of claim 14, wherein the retailer sales locations transmit sales data at a specified timeframe through the communications network to the supplier computing system and the supplier computing system aggregates the sales data for a monitoring timeframe.

16. The consignment system of claim 15, wherein the specified timeframe is real-time or as a short timeframe after a sale of the consigned products takes place.

17. The consignment system of claim 16, wherein the supplier computer system receives the sales out data, analyzes the sales data for the monitoring timeframe to determine a replenishment quantity of consigned products and a corresponding stocking location of the replenishment quantity of consigned products, creates a replenishment order identifying the replenishment quantity of consigned products to be shipped to the retailer distribution system and the corresponding stocking location for the consigned products, and transmits the replenishment order to the supplier inventory location.

18. The consignment system of claim 17, further including the supplier inventory location receiving the replenishment order and shipping out the replenishment quantity of consigned products to the retailer distribution system.

19. The consignment system of claim 14, wherein the plurality of retail sales locations transmits sales information to the retailer computer system at a specified timeframe, the retailer computer system receives the sales information from the plurality of retail sales locations and aggregates the sales information from the plurality of retail sales location, and the retailer computer system transmits the aggregated sales information to the consignor computer system.

20. A computer-readable medium having encoded thereon a computer-readable program code which when executed causes a computer to:
receive an initial consignment inventory request from a retailer or consignee;
analyze the initial consignment inventory request to determine an initial consignment stocking level order;
transmit the initial consignment stocking level order to a consignor inventory location; and
create a virtual inventory record corresponding to the initial consignment stocking level order and detailing a quantity of consigned products stocked in a consignee distribution system plus a location of each of the consigned products.

21. A computer-readable medium having encoded thereon a computer-readable program code which when executed causes a computer to:
receive sales information of a consigned product from the retailer;
generate an invoice based on the sales information of the consigned product;
decrement a virtual inventory record based on the sales information of the consigned product, wherein the virtual inventory record tracks stocking levels at each inventory location in a retailer distribution system; and
create an accounts receivable record for the retailer corresponding to the invoice generated based on the sales information.

22. The computer-readable medium of claim 21 having further encoded thereon a computer-readable program which when executed causes a computer to:
receive a remittance of a certain value from the retailer and to decrease the accounts receivable record based by the remittance of the certain value.
